(19) United States
(12) Patent Application Publication
(10) Pub. No.: US 2026/0198534 A1
(43) Pub. Date: Jul. 16, 2026

(54) REDUCTION OF ASTRINGENCY IN PLANT PROTEIN BASED BEVERAGES

(71) Applicant: SOCIÉTÉ DES PRODUITS NESTLÉ S.A., Vevey (CH)

(72) Inventors: Marine DEVEZEAUX DE LAVERGNE, Lausanne (CH); Jan ENGMANN, Lausanne (CH); Christoph HARTMANN, Epalinges (CH); Benjamin, Jean, Didier LE REVEREND, Kirkwood, MO (US)

(21) Appl. No.: 19/131,308

(22) PCT Filed: Nov. 23, 2023
(86) PCT No.: PCT/EP2023/082906

§ 371 Date: May 20, 2025

(30) Foreign Application Priority Data
Nov. 25, 2022 (EP) 22209549.9

(51) Int. Cl. A23L 2/66; A23J 3/14; A23L 29/206

(52) U.S. Cl. CPC A23L 2/66; A23J 3/14; A23L 29/206

(57) ABSTRACT

The invention relates to a plant protein based drink comprising oat bran or oat bran extract, wherein said oat bran or oat bran extract comprises between 0.1% to 6% of the total solid content on a dry basis in the plant protein based drink, and wherein at least 15% of the solids on a dry basis contributed by the oat bran or oat bran extract are beta-glucans.

### INTRODUCTION

Astringency or the sensation of dry-mouthfeel is a sensorial defect that is perceived in some protein based beverages, either due to a high protein content or due to the composition of the source material such as plant based proteins. This perception is hypothesized to be generated from the depletion of the lubricative salivary film, by protein aggregation of the saliva or physical removal by abrasive protein aggregates.

Thickening a beverage by using hydrocolloids, for example carboxymethyl-cellulose, pectins, and guar gums, has been proven to lower perceived astringency. However, this effect is limited, especially as the viscosity of the beverage remains within a low range. Moreover, most hydrocolloid thickeners are not perceived as clean label and might be rejected by consumers.

There is a clear need to develop non-astringent plant based beverages which are clean label and therefore have a better perception amongst consumers.

### SUMMARY OF THE INVENTION

The present invention relates to the use of oat bran or an oat bran extract rich in beta-glucans, in order to lower dry mouthfeel perception. This extract is used at very low concentrations (below 0.2%) and lowers astringency perception to a greater extent than gums when used at a comparable level of bulk viscosity. The extensional rheological properties of oat bran extract can mimic saliva and therefore restore lubrication in presence of astringent compounds.

### EMBODIMENTS OF THE INVENTION

The invention relates in general to a plant protein based drink comprising oat bran or oat bran extract.

In one embodiment, the plant protein based drink comprises between 0.3 wt % to 0.5 wt % oat bran.

In one embodiment, the oat bran or oat bran extract comprises between 10% to 35% of the total solid content on a dry basis in the plant protein based drink.

In one embodiment, the oat bran or oat bran extract comprises between 20% to 35% of the total solid content on a dry basis in the plant protein based drink.

In one embodiment, the oat bran or oat bran extract comprises between 15% to 35% of the total solid content on a dry basis in the plant protein based drink.

In one embodiment, the oat bran or oat bran extract comprises between 10 to 35% of the total solid content on a dry basis in the plant protein based drink.

In one embodiment, the oat bran or oat bran extract comprises less than 6% of the total solid content on a dry basis in the plant protein based drink.

In one embodiment, the oat bran or oat bran extract comprises less than 6% of the total solid content on a dry basis in the plant protein based drink, and wherein at least 15% of the solids on a dry basis contributed by the oat bran or oat bran extract are beta-glucans.

In one embodiment, the oat bran or oat bran extract comprises not less than 0.1% of the total solid content on a dry basis in the plant protein based drink, and wherein at least 15% of the solids on a dry basis contributed by the oat bran or oat bran extract are beta-glucans.

In one embodiment, the oat bran or oat bran extract comprises between 0.1 to 6% of the total solid content on a dry basis in the plant protein based drink.

In one embodiment, where the plant protein based drink comprises oat bran, then the oat bran comprises between 1 to 5% of the total solid content on a dry basis in the plant protein based drink. Preferably, oat bran comprises about 3% of the total solid content on a dry basis in the plant protein based drink.

In one embodiment, up to 50% of the solids contributed by the oat bran are beta glucans. In one embodiment, between 25 to 35% of the solids contributed by the oat bran are beta glucans. In one embodiment, at least 28% of the solids contributed by the oat bran are beta glucans.

In one embodiment, oat bran extract comprises between 1 to 5% of the total solid content on a dry basis in the plant protein based drink. Preferably, oat bran extract comprises about 3%, or between 3% to 5%, of the total solid content on a dry basis in the plant protein based drink.

In one embodiment, the plant protein based drink comprises less than 6 wt % plant protein.

In one embodiment, the plant protein based drink comprises less than 4 wt % plant protein.

For example, in the case where a pea protein isolate has a protein content of 80%, then the protein content of a plant based drink comprising 4.5 wt % pea protein isolate is 3.6%.

In one embodiment, the plant protein based drink comprises about 3.6 wt % plant protein.

In one embodiment, the plant protein based drink comprises less than 2.5 wt % plant protein.

In one embodiment, the plant protein based drink comprises between 0.5 wt % to 6 wt %, or between 0.5 wt % to 4 wt %, or between 0.5 wt % to 2.5 wt % plant protein.

In one embodiment, said wt % amount of plant protein does not include plant protein contributed by oat bran or oat bran extract.

In one embodiment, the oat bran is solubilized in the plant protein based drink.

In one embodiment, the plant protein is pea protein. In one embodiment, the plant protein is fava protein. In one embodiment, the plant protein is soy protein. In one embodiment, the plant protein is a plant protein isolate. In one embodiment, the plant protein is pea protein isolate.

In one embodiment, the plant protein based drink comprises pea protein isolate and oat bran extract, for example about 3.6 wt % pea protein on a dry basis and about 3 wt % oat bran extract on a dry basis.

In one embodiment, the oat bran extract solid comprises at least 15% beta-glucans on a dry basis. In one embodiment, the oat bran extract solid comprises between 25 to 50% beta-glucans on a dry basis. In one embodiment, the oat bran extract solid comprises between 40 to 50% beta-glucans on a dry basis. Preferably, the oat bran extract solid comprises up to 50% beta-glucans on a dry basis.

In one embodiment, the plant protein based drink is vegan. In one embodiment, the drink does not comprise gums, preferably the drink does not comprise gellan gum, pectin, or xanthan gum. In one embodiment, the drink is vegan and does not comprise gums.

In one embodiment, the plant protein based drink further comprises oil, preferably up to about 4 wt % oil on a dry basis.

In one embodiment, the plant protein based drink comprises about 2.5 wt % sunflower oil.

In one embodiment, the plant protein based drink comprises between 0.5 to 3.5 wt % sugar on a dry basis. In one embodiment, the plant protein based drink comprises up to about 3.5 wt % sugar on a dry basis, for example about 0.8 wt % brown sugar on a dry basis.

In one embodiment, the plant protein based drink comprises flavors.

In one embodiment, the plant protein based drink comprises up to 1 wt % gums, for example about 0.15 wt % gums.

In one embodiment, the plant protein based drink comprises demineralized water. In one embodiment, the plant protein based drink comprises about 0.22 wt % Ca(OH)₂ and phosphoric acid in about a 1.3 massic ratio with calcium.

In one embodiment, the plant protein based drink comprises about 5.1 wt % isomaltulose.

In one embodiment, the plant protein based drink comprises about 0.12 wt % monopotassium phosphate.

In one embodiment, the plant protein based drink comprises about 0.35 wt % calcium carbonate.

The invention further relates to a method of preparing an oat bran extract, comprising the steps:
a. solubilization of oat bran in water, for example demineralized water;
b. centrifugation of insoluble components; and
c. separation of supernatant from insoluble components, wherein the supernatant is an oat bran extract.

In one embodiment, the temperature of the water is at least 60° C., for example about 65° C.

In one embodiment, the drink is prepared by hydrating plant protein isolate in water.

In one embodiment, the drink is prepared by homogenization and pasteurization.

In one embodiment, oat bran extract is added after pasteurization.

In one embodiment, oat bran is added when hydrating plant protein isolate in water.

The invention further relates to a method of preparing a plant protein based drink comprising oat bran extract, wherein said oat bran extract comprises less than 6% of the total solid content on a dry basis in the plant protein based drink.

In one embodiment, the oat bran extract comprises less than 6% of the total solid content on a dry basis in the plant protein based drink, wherein at least 15% of the solids on a dry basis contributed by the oat bran extract are beta-glucans.

In one embodiment, the method comprises adding sunflower oil and gums and stirring.

In one embodiment, the method comprises homogenizing in a two stage homogenizer, for example at a pressure of 250/50 Bars.

In one embodiment, the method comprises a pasteurization step, for example at about 95° C. for about 15 min. Preferably, where oat bran extract is used, this is added after pasteurization. Preferably, where oat bran is used, this is added during a hydration step together with the plant protein isolate.

In one embodiment, the oat bran or oat bran extract comprises not less than 0.1% of the total solid content on a dry basis in the plant protein based drink, and wherein at least 15% of the solids on a dry basis contributed by the oat bran or oat bran extract are beta-glucans.

In one embodiment, the oat bran or oat bran extract comprises between 0.1 to 6% of the total solid content on a dry basis in the plant protein based drink.

In one embodiment, the oat bran extract is made by a method according to the invention.

In one embodiment, the plant protein based drink comprises less than 6 wt % plant protein.

In one embodiment, the plant protein based drink comprises less than 4 wt % plant protein.

In one embodiment, the plant protein based drink comprises about 3.6 wt % plant protein.

In one embodiment, the plant protein based drink comprises less than 2.5 wt % plant protein.

In one embodiment, the plant protein based drink comprises between 1 to 6 wt % plant protein.

In one embodiment, the plant protein is pea protein. In one embodiment, the plant protein is fava protein. In one embodiment, the plant protein is soy protein. In one embodiment, the plant protein is a plant protein isolate. In one embodiment, the plant protein is pea protein isolate.

In one embodiment, the plant protein based drink comprises pea protein isolate and oat bran extract, for example about 3.6 wt % pea protein on a dry basis and about 3 wt % oat bran extract on a dry basis.

In one embodiment, the oat bran extract solid comprises at least 15% beta-glucans on a dry basis. Preferably, the oat bran extract solid comprises up to 50% beta-glucans on a dry basis.

In one embodiment, the plant protein based drink is vegan. In one embodiment, the drink does not comprise gums, preferably the drink does not comprise gellan gum, pectin, or xanthan gum. In one embodiment, the drink is vegan and does not comprise gums.

In one embodiment, the plant protein based drink further comprises oil, preferably up to about 4 wt % oil on a dry basis.

In one embodiment, the plant protein based drink comprises about 2.5 wt % sunflower oil.

In one embodiment, the plant protein based drink comprises up to about 3.5 wt % sugar on a dry basis, for example about 0.8 wt % brown sugar on a dry basis.

In one embodiment, the plant protein based drink comprises flavors.

In one embodiment, the plant protein based drink comprises up to 1 wt % gums, for example about 0.15 wt % gums.

In one embodiment, the plant protein based drink comprises about 0.22 wt % Ca(OH)₂ and phosphoric acid in about a 1.3 massic ratio with calcium.

In one embodiment, the plant protein based drink comprises about 5.1 wt % isomaltulose.

In one embodiment, the plant protein based drink comprises about 0.12 wt % monopotassium phosphate.

In one embodiment, the plant protein based drink comprises about 0.35 wt % calcium carbonate.

In one embodiment, at least 50% of the solids on a dry basis contributed by the oat bran extract are beta-glucans.

The invention further relates to the use of oat bran or oat bran extract for reducing astringency persistency in a plant protein based drink, preferably a pea protein based drink.

The invention further relates to the use of oat bran or oat bran extract for increasing body perception in a plant protein based drink, preferably a pea protein based drink.

### DETAILED DESCRIPTION

All percentages expressed herein are by weight of the total weight of the composition unless expressed otherwise.

As used herein, “about,” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number. All numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

As used in this disclosure and the appended claims, the singular forms “a,” “an” and “the” include plural referents unless the context clearly dictates otherwise. Thus, for example, reference to “an ingredient” or “the ingredient” includes two or more ingredients.

The words “comprise,” “comprises” and “comprising” are to be interpreted inclusively rather than exclusively. Likewise, the terms “include,” “including” and “or” should all be construed to be inclusive, unless such a construction is clearly prohibited from the context. Nevertheless, the compositions disclosed herein may lack any element that is not specifically disclosed herein. Thus, a disclosure of an embodiment using the term “comprising” includes a disclosure of embodiments “consisting essentially of” and “consisting of” the components identified. A composition “consisting essentially of” contains at least 75 wt. % of the referenced components, preferably at least 85 wt. % of the referenced components, more preferably at least 90 wt. % of the referenced components, most preferably at least 95 wt. % of the referenced components.

The term “and/or” used in the context of “X and/or Y” should be interpreted as “X,” or “Y,” or “X and Y.” Where used herein, the terms “example” and “such as,” particularly when followed by a listing of terms, are merely exemplary and illustrative and should not be deemed to be exclusive or comprehensive.

The plant-based protein can be, for example, pea protein (all forms including concentrate and isolate), soy protein (all forms including concentrate and isolate), canola protein (all forms including concentrate and isolate), other plant proteins such as wheat and fractionated wheat proteins, corn and it fractions including zein, rice, oat, potato, peanut, green pea powder, green bean powder, and any proteins derived from beans, lentils, and pulses.

Non-limiting examples of suitable lipid include vegetable fat (such as olive oil, corn oil, sunflower oil, rapeseed oil, hazelnut oil, soy oil, palm oil, coconut oil, canola oil, lecithins, and the like), or any combinations thereof.

A vegan product is defined as being devoid of animal products, for example devoid of dairy products and meat products.

### EXAMPLES

### Example 1

A pea based drink was made by solubilizing 4.5 wt % pea protein isolate (with a protein content of 80%) and 0.8 wt % sugar in demineralized water (or demineralized water with 0.22 wt % Ca(OH)₂ and phosphoric acid in about a 1.3 massic ratio with calcium) at 65° C., heating and stirring 30 min, then adding additional ingredients (including sunflower oil at 2.5 wt %, and gums at 0.15 wt %) and stirring 15 minutes (still at 65° C.). The mixture was homogenized in a two stage homogenizer at a pressure of 250/50 Bars and pasteurized at 95° C. for 15 min. Where oat bran extract was used, this was added after pasteurization. Where oat bran was used, this was added at the hydration step together with the pea protein isolate.

For sensory, 12 panelists were trained to perform monadic descriptive profiling on several sensory attributes related to the flavor and texture until they reached good discrimination and reproducibility.

During the evaluation, the panelists were instructed to evaluate the samples on the attributes from a defined sensory glossary. The attributes covered AR=Aroma; FL=Flavour; TX=Texture and PE=Persistence 30 seconds after spitting the sample out. The perceived magnitudes were recorded on visual analog structured scale varying from 0 to 10 and the samples were presented one at a time to the panelists.

Samples were tested 18 to 20 hours after preparation at room temperature (about 20° C.). To avoid saturation effect, a maximum of 6 products were evaluated for each single session with 5 minutes pause between the samples during which panelists were provided with freshly opened Acqua Panna water as palate cleaner. Monadic profiling data were collected using Fizz software (Biosystèmes, France) in individual sensory booths.

For shear viscosity, a single flow curve of each samples was measured using an Anton Paar Rheometer with a double gap geometry (DG 26,7; Serial number 28531) at 20° C. between shear 10-1 and 102 s-1. For measured extensional viscosity, the Haake™ Capillary Break-up Extensional Rheometer (CaBER™, ThermoFisher Scientific, N^{o} 40047807) was used. This device produces a fluid filament by rapidly stretching a drop of liquid sample vertically and then follows the thinning of this filament. The pea based drink sample was loaded between two metallic plates of a 6 mm diameter spaced by 3 mm and extended by a linear motor drive to a height of 10 mm. A laser sheet was used to measure the diameter of the midpoint of the liquid sample during extension and thinning until it broke. Six replicates were used for each sample, an average curve as well as an average breakup time were extracted.

### Example 2

In this example, an extract from oat brans was used with hot water extraction and centrifugation of the insoluble. The supernatant was used as extract containing about 0.3% total solids, including 0.15% beta-glucans. The extensional properties of the extract was a breakup time of 756±131 ms and a relaxation time of 243±15 ms and a filament breakup curve of the following:

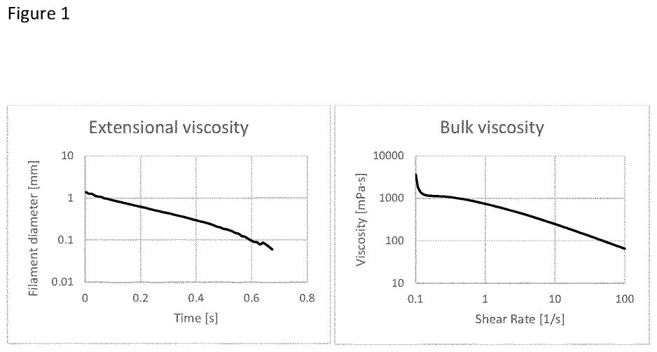

FIG. 1 shows filament diameter over time using a CaBER, and bulk viscosity over shear using a rheometer.

This extract was used in a pea protein based drink recipe by replacing 20% water in the recipe with oat bran extract. The pea protein drink contained 4.5 wt % pea protein isolate from a commercial source, 0.22 wt % Ca(OH)₂ and phosphoric acid in about a 1.3 massic ratio with Calcium, and 5.1 wt % of isomaltulose. A control containing 0.17 wt % pectins was used to de-couple the effect of bulk and extensional viscosity.

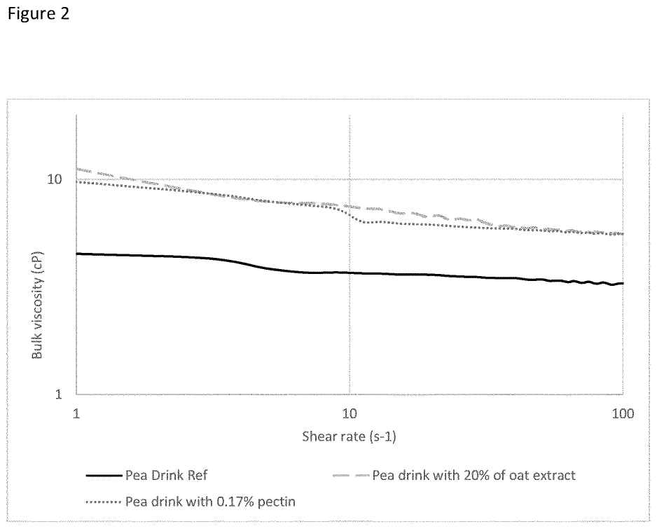

FIG. 2 shows a flow viscosity profile of samples tested by the sensory panel, using a double gap geometry on an Anton Paar Rheometer. First results obtained on a recipe without sugar. The bulk viscosity was comparable between the recipe with oat bran extract and the recipe with 0.17% wt % pectins, as shown in FIG. 2. The sensory profile show a significant decrease in astringency persistency (tends to be lower in TX-Astringency) and a significant increase in body perception with the oat bran extract compared to the pectin.

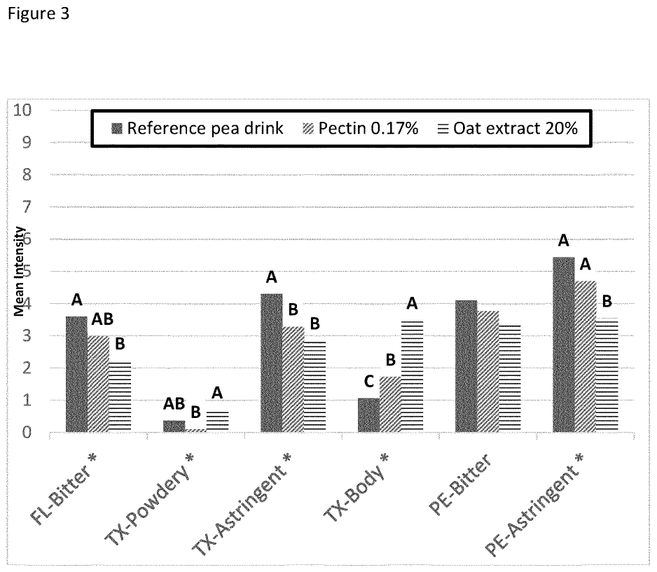

FIG. 3 shows the sensory scores of a trained panel (N=10). Different significant letters indicate a significant difference between samples (Duncan, P<0.05)

### Example 3

In this example, the extensional viscosity is not coming from an oat bran extract, but a beta-glucan enriched oat bran from a commercial source, also containing insoluble fibers. This oat bran was used in a pea based drink containing 4.4 wt % pea protein isolate (with 80% protein) from a commercial source, 0.80 wt % brown sugar, 2.60 wt % high oleic sunflower oil, 0.12 wt % monopotassium phosphate and 0.35 wt % calcium carbonate.

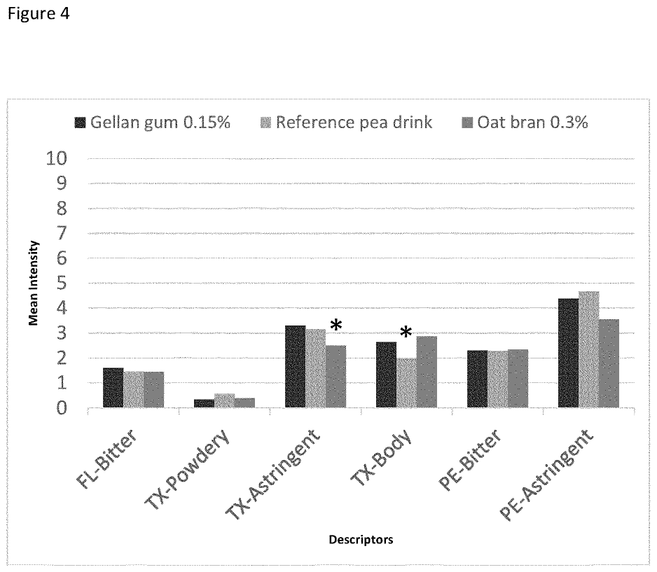

FIG. 4 shows sensory scores of a trained panel (N=10). A star indicates a significant difference between samples (Duncan, P<0.05). It can be seen in FIG. 4 that the perceived body of a sample thickened by a gum is not significantly different from perceived body of the oat bran sample. However, the Astringency (Texture) is perceived lower in the recipe with oat bran compared to the un-thickened and the gellan thickened reference. The persistent astringency tends to be lower as well.

In addition, it can be seen that the bulk viscosity of the gellan sample is higher than the viscosity of the recipe with oat bran, suggesting that the decrease in astringency is not coming from a higher bulk viscosity in the oat bran sample.

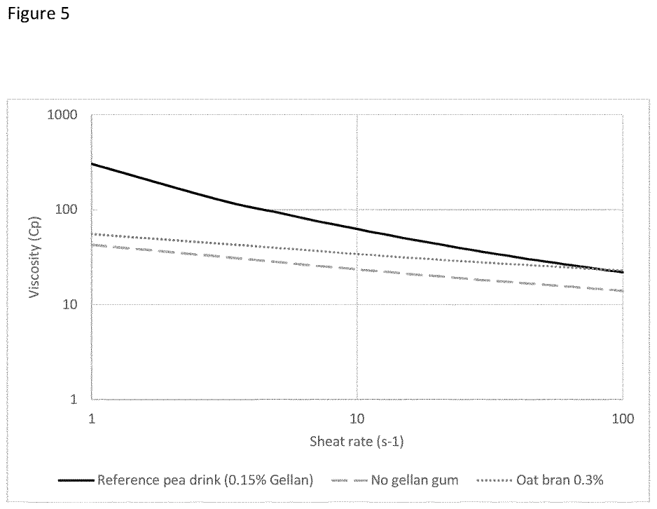

FIG. 5 shows a flow viscosity profile of samples tested by the sensory panel, using a double gap geometry on an Anton Paar Rheometer.

### Example 3

In this example, an oat bran extract was used at various levels in the pea protein drink from example 2, ranging between 5% to 20% addition.

TABLE 1
Time to fracture of a filament of a controlled
amount of sample using a caber

| Recipe | Time to filament fracture (ms) |
|---|---|
| 20% oat bran extract | 153 ± 18 |
| 10% oat bran extract | 59 ± 16 |
| 5% oat bran extract | 39 ± 7 |
| Pea drink ref | 36 ± 4 |

The final concentration of oat bran extract in the plant protein based drink was between 0.1 and 1% on a dry basis.

These results show that the added extract only modified the extensional viscosity of the drink at 20% and 10% addition, but not at the lower 5% additions.

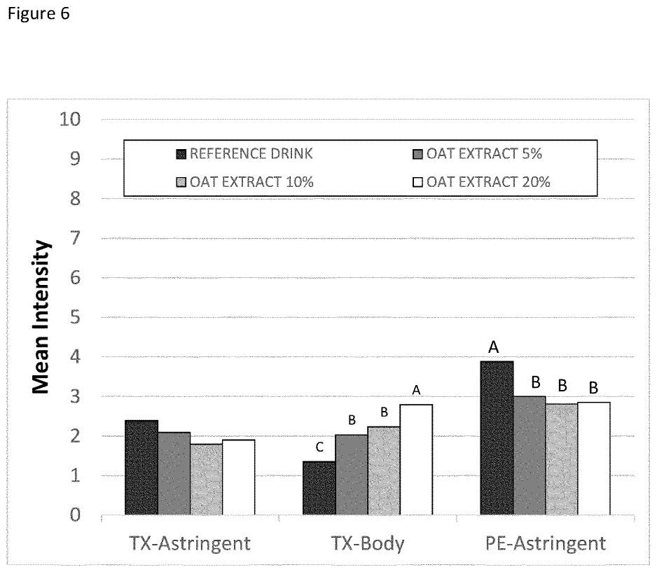

FIG. 6 shows the mean sensory scores (N=12) of pea based drinks with different amounts of oat bran extract addition. Different letters indicate significant differences between the samples (Duncan, P<0.05).

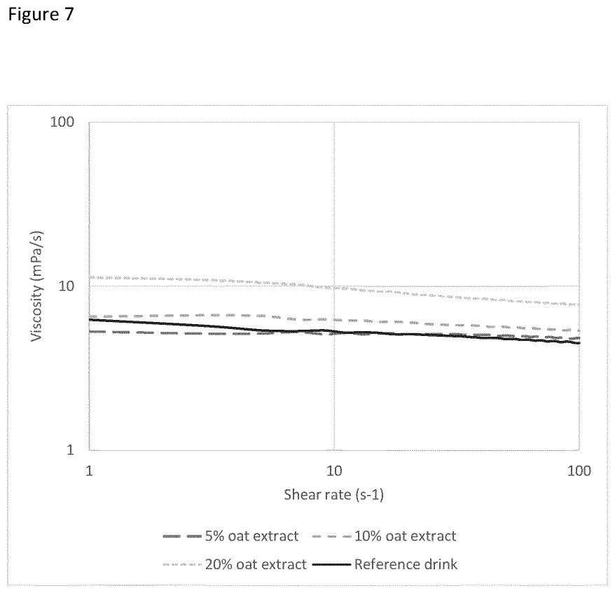

FIG. 7 shows flow viscosity profile of samples tested by the sensory panel, using a double gap geometry on an Anton Paar Rheometer. The bulk viscosity of this mixture did not increase, suggesting that the decrease in astringency and the increase in body perception is linked to the use of oat bran extract and not to the bulk viscosity of the final recipe.

### Example 4

In this example, an oat bran rich in beta glucans (28%) was used as ingredient in a plant protein beverage. The composition of said plant-based beverage is shown in Table 2 below.

TABLE 2
Composition of a plant based beverage

| | Reference | No-gum | 0.3 Oat | 0.5 Oat |
|---|---|---|---|---|
| Raw material | wt % | wt % | wt % | wt % |
| Pea protein isolate | 4.53% | 4.53% | 4.53% | 4.53% |
| Sugar | 0.80% | 0.80% | 0.80% | 0.80% |
| Oil Sunflower | 2.60% | 2.60% | 2.60% | 2.60% |
| Gum Gellan | 0.15% | | | |
| Oat Bran | | | 0.30% | 0.50% |
| Demi-Water | Up to | Up to | Up to | Up to |
| | 100% | 100% | 100% | 100% |

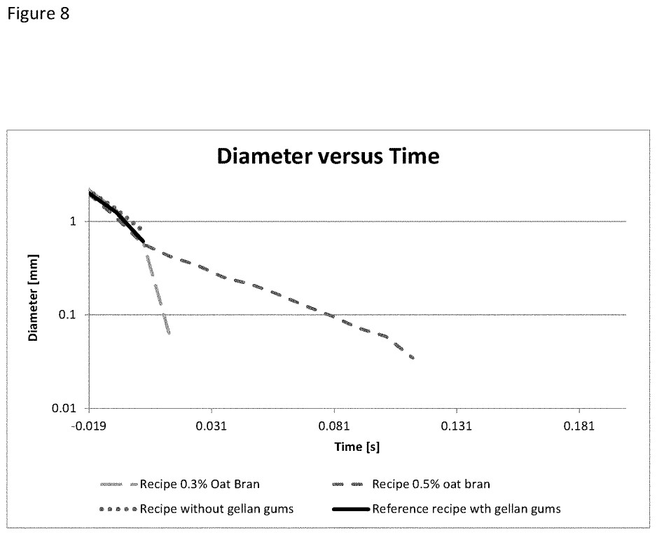

The addition of oat bran to the recipe resulted in an increase in extensional viscosity, comparable as the addition of oat bran extract. This is seen in FIG. 8, which shows filament diameter over time using a CaBER.

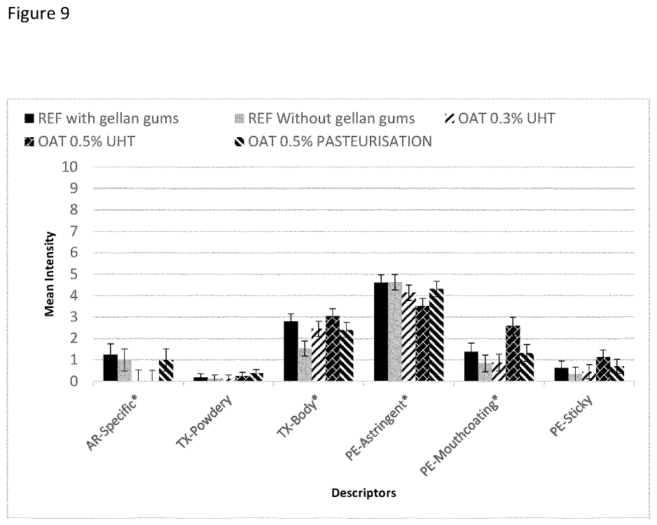

FIG. 9 shows sensory scores on plant-based beverages containing oat bran produced at pilot plant scale with a UHT treatment. The sensory scores show that an increase concentration in oat bran results in a decrease of astringency perception (PE-Astringent), as well as an increase in mouthcoating perception. These results confirm the benefit of adding oat bran to a plant based beverage within a concentration of 0.3 and 0.5 wt % of the beverage, corresponding to a concentration of 3 to 5 wt % of the total solid content.

1: A plant protein based drink comprising oat bran or oat bran extract, wherein the oat bran or oat bran extract comprises between 0.1% to 6% of total solid content on a dry basis in the plant protein based drink, and wherein at least 15% of solids on a dry basis contributed by the oat bran or oat bran extract are beta-glucans.

2: The plant protein based drink according to claim 1, wherein the oat bran or oat bran extract comprises between 1 to 5% of the total solid content on a dry basis in the plant protein based drink.

3: The plant protein based drink according to claim 1, wherein the plant protein based drink comprises between 0.3 wt % to 0.5 wt % oat bran.

4: The plant protein based drink according to claim 1, comprising at least one of wherein the plant protein is pea protein, fava protein, or soy protein.

5: The plant protein based drink according to claim 1, comprising pea protein isolate.

6: The plant protein based drink according to claim 1, wherein the plant protein based drink comprises less than 4.5 wt % plant protein.

7: The plant protein based drink according to claim 1, wherein up to 50% of the solids contributed on a dry basis by the oat bran extract are beta-glucans.

8: The plant protein based drink according to claim 1, wherein between 25 to 35% of the solids contributed on a dry basis by the oat bran are beta-glucans.

9: The plant protein based drink according to claim 1, wherein the plant protein drink comprises pea protein isolate and oat bran extract.

10: The plant protein based drink according to claim 1, wherein the drink is vegan and does not comprise gums.

11: A method of preparing a plant protein based drink comprising oat bran extract, wherein the oat bran extract comprises less than 6% of the total solid content on a dry basis in the plant protein based drink, wherein at least 15% of the solids on a dry basis contributed by the oat bran extract are beta-glucans.

12: The method according to claim 11, wherein the drink is prepared by hydrating plant protein isolate in water.

13: The method according to claim 11, wherein the drink is prepared by homogenization and pasteurization.

14: The method according to claim 11, wherein oat bran extract is added after pasteurization.

15: The method according to claim 11, wherein oat bran is added when hydrating plant protein isolate in water.

16: A method for reducing astringency persistency or for increasing body perception in a pea protein based drink, the method comprising adding oat bran or oat bran extract to pea protein.
